(19) United States
(12) Patent Application Publication
(10) Pub. No.: US 2014/0319282 A1
(43) Pub. Date: Oct. 30, 2014

(54) Space station configuration

(71) Applicant: Robert T. Bigelow, Las Vegas, NV (US)

(72) Inventor: Robert T. Bigelow, Las Vegas, NV (US)

(73) Assignee: Bigelow Development Aerospace

(21) Appl. No.: 13/986,418

(22) Filed: Apr. 30, 2013

(51) Int. Cl. B64G 1/12

(52) U.S. Cl. CPC B64G 1/12
USPC 244/159.4

(57) ABSTRACT

An inflatable module space station is disclosed. The module has an avionics architecture designed for the module serving as a space station. The module also has at least one hundred and eighty cubic meters of internal habitable volume and at least one window. The module is capable of supporting at least two humans in a zero gravity environment for at least one month. There is also a propulsion bus designed for a space station and attached to the module. Furthermore, there is a docking mechanism designed for a space station and attached to the module. The module is capable of orbiting a mass like a planet or moon. The space station can be one or multiple expandable modules.

### FIELD OF THE INVENTION

This invention generally relates to configurations for space stations and in particular to space stations comprised of inflatable modules.

### BACKGROUND OF THE INVENTION

As humanity ventures into outer space there is a need for space structures to fulfill multiple mission tasks. The space station is ideally suited to perform various functions. The stations can be destinations themselves for travelers and researchers. Stations may also form the jumping off point for deep space exploration and colonization. Also, the space stations can serve as a refueling point and way station for long missions.

One of the biggest advances in the area of manned space exploration has been the development of the expandable habitable module. These modules are launched in a compressed state and upon deployment are inflated into an expanded state. The expanded state provides a large volume for human habitation. These modules are preferable in many regards to hard shelled structures.

Traditional methods of launching hard shelled structures can only provide a fraction of the volume that is available with an inflatable craft. With the high cost of placing an object into orbit, the use of hard shelled structures could be prohibitive while expandable structures remain a viable alternative. The expandable module thus allows for an efficient and cost effective method of providing large volumes of inhabitable enclosures in space.

While U.S. Pat. No. 6,231,010 to Schneider, et al, discloses a type of inflatable structure, this structure is not directed to space stations, but rather is a listing of components that would form an inflatable structure. There is also definition as in U.S. Pat. No. 6,547,189 to Raboin, et al, FIG. 21, to inflatable modules that appear to be directed to a structure for use on extraterrestrial bodies and not toward a space station. Furthermore, U.S. Pat. No. 6,439,508 to Taylor identifies inflatable structures connected together in space, but those structures do not take into account the characteristics of a space station comprised of habitable modules.

The prior art identifies some structural characteristics of inflatable modules. However, this falls short of what an inflatable space station really is or does. What constitutes an inflatable space station along with the purpose and role of the station is needed that can be applied to single module or multiple modules in combination.

### SUMMARY OF THE INVENTION

A space station that can be comprised of at least one expandable module. The module has an avionics architecture designed for the module serving as a space station. There is also all the systems necessary to support human life. There are also communication systems for communicating with other space craft and for communicating with terrestrial bases.

The module also has at least one window. The module is capable of supporting at least one human in a zero gravity environment for at least one month. There is also a propulsion bus designed for a space station and attached to the module. Furthermore, there is a docking mechanism designed for a space station and attached to the module. The module is capable of orbiting a mass like a planet or moon.

In another embodiment, multiple modules can be combined to form a space station. Combinations can be made using connecting nodes. Multiple habitable and nonhabitable modules of various sizes can form the space station. Modules can be for various purposes.

### BRIEF DESCRIPTION OF THE DRAWINGS

The invention is generally shown by way of reference to the accompanying drawings in which:

FIG. 1 is a cutaway side view of an expandable habitable module exposing the longerons;

FIG. 2 is a top view of a first embodiment of an expandable module space station;

FIG. 3 is a top view of a second embodiment of an expandable module space station.

### DETAILED DESCRIPTION OF THE INVENTION

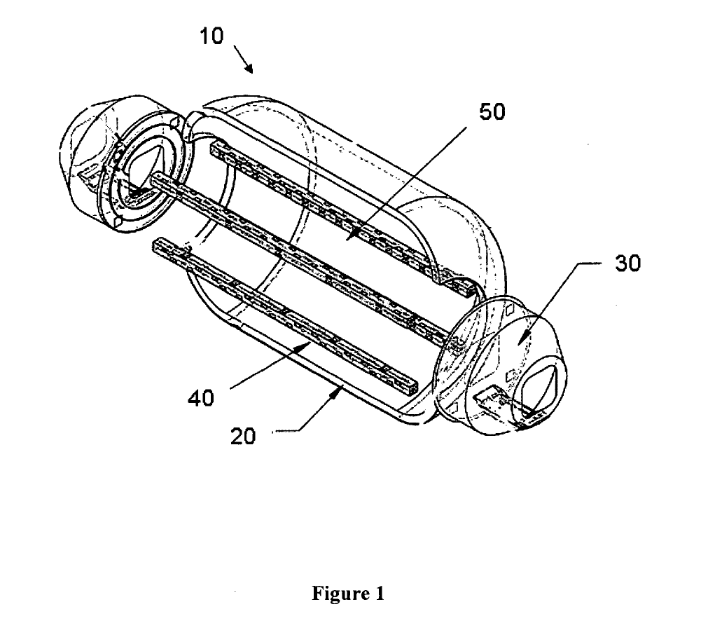

Turning to FIG. 1, a cutaway side view of an expandable habitable module 10 is identified. The module typically has an inflatable shell 20 enclosing longerons 40 that attach to the end caps 30. When deployed and inflated, there exists a large habitable volume 50 within the module. In other embodiments the module may lack longerons. In such cases, there could be opposing end caps attached to the inflatable shell. In another embodiment, there could be just one end cap and no longeron structure.

The module 10 could be used as a structure laying sideways on a planet or moon. It also could be used in an upright position on an extraterrestrial body. The module lacks definition to distinguish it as a space station.

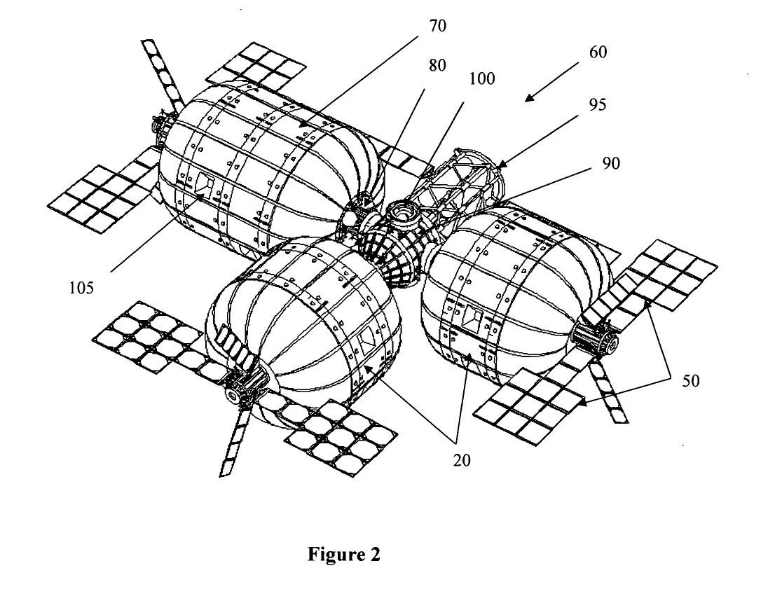

Turning to FIG. 2, one embodiment of the expandable modular space station 60 is shown. The space station 60 in this embodiment has three expandable habitable modules 70. Each module 70 has end caps 80. In this embodiment, three end caps 80 are attached to a connecting node 90. In turn, the connecting node 90 has a docking mechanism 100. There is also at least one window 105 on at least one module.

One characteristic of this embodiment is that the habitable volume is large enough to support the unique needs of humans. This space is necessary for the mental and physical health of the inhabitants and could accommodate a single person or a number of people. This is also the reason for at least one window in one of the embodiments. By way of example, it is estimated that a three hundred and thirty cubic meter environment could house six people, but this is not meant to serve as a limitation.

The present embodiment of FIG. 2 would have radiation protection designed for a space station. The protection could constitute a shielding that substantially reduces the dangerous impact of secondary radiation and hypervelocity micrometeorites and orbital debris. This would allow for longer term missions for inhabitants and protection for sensitive equipment.

There is a propulsion bus 95 that is connected to the connecting node 90 for maneuvering and station keeping. The propulsion bus 95 could also allow for transportation of the space station 60 at significant distances. The propulsion bus in this embodiment contains the fuel necessary to propel the space station. The bus is designed for the special requirements of a space station and could assist in allowing the station to retain a specific altitude for orbit or to change orbital paths.

The avionics also distinguishes a simple module from a space station. An independent avionics system is designed for a space station that would support navigation and other requirements of a space station like re-boost and docking. The station could also include communications for not only communicating with a terrestrial base, but also for communicating with deployed space craft.

The environmental controls and life support would be designed for a space station. The lack of gravity is a significant distinction between these types of systems and their terrestrial counterparts. In the zero gravity environment and orbiting a planet or moon, the environmental systems would need to have a high reliability and suited to replacement parts being brought from other sources.

Power is provided to the space station 60 through at least one array of solar cells 50. Other power sources could be utilized including nuclear reactors and batteries for mission use or backup. The power sources for a long term structure such as a space station would also be very different from those of an Earth based counterpart.

A variety of spacecraft with corresponding mating docking mechanisms can be accommodated. In this fashion, the space station 60 can receive and transfer supplies, passengers and staff.

Notably, it is the longerons that support the structure of the space station through a transfer of loads from the connecting node and docking mechanism. In a hard shelled space station, the loads would be transferred generally through the shell. This can cause stress on the shell that may impact the integrity of the internal environment. In contrast, the expandable module shell is made of generally soft materials that do not directly carry the loads associated with the connecting nodes or docking mechanisms. Thus, the outer shell of the expandable module is not prone to many of the failure mechanisms of the hard shell.

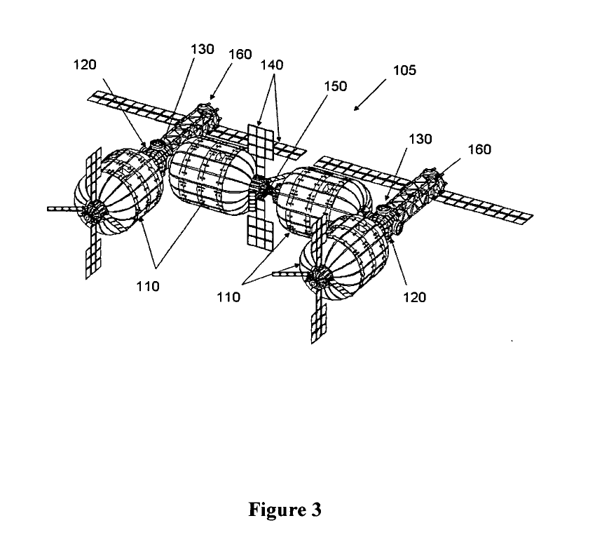

FIG. 3 is another embodiment of the space station 105. In this configuration there are four modules 110 interconnected to form a large internal volume. There are two connecting nodes 120 and one docking mechanism 150 to connect the modules 110. The docking mechanism 150 is not part of a connecting node and serves to connect two of the modules 110.

The space station is designed for low gravity environments. This is to say that the habitable volume has accoutrements that accommodate people in a low gravity or zero gravity environment. For example, there could be magnetic walkways, guide ropes from point to point, or vacuum systems for waste collection and disposal, to name just a few. Furthermore, structures within the space station could have safety features such as rubber corners to minimize impacts with people.

Due to the lack of a terrestrial base, the space station would also have a larger external area to position solar cells. Another characteristic that could distinguish the space station from a terrestrial structure would be the use of a docking mechanism for use with other spacecraft and modules.

As a craft designed for exoatmospheric use the space station would generally lack terrestrial landing structures. Furthermore, the spacecraft would be capable of a greater range of positioning in an orbit in comparison with that of a stationary landed craft.

Another advantage of the space station is the combination of a strong longeron core with the softer shell. The longeron core could form the backbone for supporting large equipment where it would be desirable to keep the equipment in a more permanent position while the soft shell could support lighter equipment or equipment that is movable. As the longerons provide the strong basis for the connections between modules, the soft shell allows for a flexible structure that is less apt to failure modes associated with rigid structures. In another embodiment, the station is designed and supported for missions exceeding thirty days. A station may perform multiple consecutive missions with different crew members so that an individual mission may be shorter than the overall lifetime service of the station. The length of time of the missions and the size of the station would allow crew members to mover about the station without the need for restraints as experienced in crew capsules servicing shorter missions.

While embodiments have been described in detail, it should be appreciated that various modifications and/or variations may be made without departing from the scope or spirit of the invention. In this regard it is important to note that practicing the invention is not limited to the applications described herein. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein. Thus, it is intended that the invention cover all such embodiments and variations. Nothing in this disclosure is intended to limit the scope of the invention in any way.

What is claimed is:

1. A space station configuration comprising:
an expandable module;
the module having an avionics architecture designed for the module serving as a space station;
the module having at least one window;
the module capable of supporting at least one human in a zero gravity environment for at least one month;
a propulsion bus designed for a space station and attached to the module;
a docking mechanism designed for a space station and attached to the module; and
the module capable of orbiting a mass for an extended period of time.

2. The space station of claim 1 further comprising a connecting node and two additional expandable modules with all three expandable modules attached to the connecting node.

3. The space station of claim 1 further comprising a connecting node and three additional expandable modules with all four expandable modules attached to the connecting node.
